(19) United States
(12) Patent Application Publication
(10) Pub. No.: US 2014/0180779 A1
(43) Pub. Date: Jun. 26, 2014

(54) AUTOMATED INCENTIVE COMPUTATION IN CROWDSOURCING SYSTEMS

(71) Applicant: INTERNATIONAL BUSINESS MACHINES CORPORATION, Armonk, NY (US)

(72) Inventors: Osamuyimen T. Stewart, Piscataway, NJ (US); Maja Vukovic, New York, NY (US)

(73) Assignee: INTERNATIONAL BUSINESS MACHINES CORPORATION, Armonk, NY (US)

(21) Appl. No.: 13/722,123

(22) Filed: Dec. 20, 2012

(51) Int. Cl. G06Q 30/02

(52) U.S. Cl. CPC G06Q 30/0208
USPC 705/14.11

(57) ABSTRACT

An embodiment of the invention pertaining to a given task to be submitted for crowdsourcing computes an initial incentive range having minimum, maximum and midrange incentives, the maximum incentive being equal to a prespecified maximum incentive value. Historical data pertaining to tasks of the given type that were previously crowdsourced is acquired, wherein the historical data includes completion time and incentive information. The historical data is used with the minimum, midrange and maximum incentives to compute minimum, midrange and maximum incentive task completion times. These completion times are used to determine whether a first, second, or a third criterion has been met, and responsive to a first or second criterion being met, the given task is transformed, and the incentive range is updated, for use in computing a final incentive value.

### BACKGROUND

1. Field

The invention disclosed and claimed herein generally pertains to crowdsourcing software related tasks. More particularly, the invention pertains to computation of an optimized incentive, which will be offered for successful task completion.

2. Description of the Related Art

As is known by those of skill in the art, crowdsourcing has developed as an increasingly popular approach for performing certain kinds of important tasks. In a crowdsourcing effort or procedure, a large group of organizations, individuals and other entities that desire to provide pertinent services, such as a specific community of providers, or the general public, are invited to participate in a task that is presented by a task requester. Examples of such tasks include, but are not limited to, developing specified software components or the like. As used by those of skill in the art, and also as used herein, the term “crowdsourcing marketplace” means or refers to all the prospective providers of crowdsourcing services for a given type of task, collectively.

Currently, a crowdsourcing platform may serve as a broker or intermediary between the task requester and the crowdsourcing marketplace. Crowdsourcing platforms generally allow requesters to publish or broadcast their tasks to the crowdsourcing marketplace, and further allow a participating provider that is successful in completing a task to receive an incentive or other monetary award.

At present however, there is no systematic way to compute or determine the incentive amount that is offered for completion of a given task. Details for this determination are generally left to the crowdsourcing task requesters, which often results in suboptimal and inefficient incentives. Also, multiple parameters of the dynamic crowdsourcing marketplace are generally not taken into account in computation of task incentives.

While a task requester will not want to offer an incentive that is unnecessarily high, it can also be undesirable to offer the crowdsourcing marketplace an incentive that is too low for a given task. An incentive which is too low may discourage the most skilled task providers from accepting the associated task. This could result in unsuccessful task performance, including failure to complete the given task within a required time frame. Generally, offering inappropriate incentives for tasks can cause mismatch between supply and demand in the crowdsourcing marketplace.

### SUMMARY

Embodiments of the invention provide a method, system and computer program product for achieving multivariable optimization in computing crowdsourcing task incentives. This optimization is based on considerations such as task complexity, skills required for task performance, and optimal participation of crowdsourcing providers. Embodiments of the invention further provide automated incentive computation of complex, decomposable tasks in crowdsourcing marketplaces.

An embodiment directed to a method is associated with a specified task of a given type which is to be submitted to a crowdsourcing marketplace for execution, wherein task execution must be completed within a specified maximum time. Also the incentive offered for task execution cannot exceed a specified maximum incentive value. The embodiment includes the step of computing an initial incentive range having values for a minimum incentive, a midrange incentive, and a maximum incentive, wherein the maximum incentive is equal to the specified maximum incentive value. The method further includes acquiring historical data pertaining to tasks of the given type which were previously executed by crowdsourcing, wherein the historical data includes at least completion times and incentives of the previously executed tasks. The method further includes using the historical data with the minimum incentive, the midrange incentive and the maximum incentive to compute, respectively a minimum incentive task completion time (CT[B(C)ₘᵢₙ]), a midrange incentive task completion time (CT[B(C)_{mid}]), and a maximum incentive task completion time (CT[B(C)ₘₐₓ]). The method further includes selectively processing CT[B(C)ₘᵢₙ], CT[B(C)_{mid}], and CT[B(C)ₘₐₓ] to determine whether a first criterion, a second criterion or a third criterion has been complied with. The method further includes, responsive to determining that either the first criterion or the second criterion has been complied with, selectively transforming the specified task, and computing on updated incentive range for the transformed task. The method further includes using the transformed task and updated incentive range in computing a final incentive value, for submission with at least a portion of the specified task to the crowdsourcing marketplace.

### BRIEF DESCRIPTION OF THE SEVERAL VIEWS OF THE DRAWINGS

FIG. 1 is a schematic diagram illustrating a crowdsourcing process in accordance with an embodiment of the invention.

FIG. 2 is a schematic diagram illustrating exemplary tasks for an embodiment of the invention.

FIG. 3 is a flowchart showing steps for a method comprising an embodiment of the invention.

FIG. 4 is a block diagram showing a network of data processing systems in which an embodiment of the invention may be implemented.

FIG. 5 is a block diagram showing a computer or data processing system that may be used in implementing embodiments of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

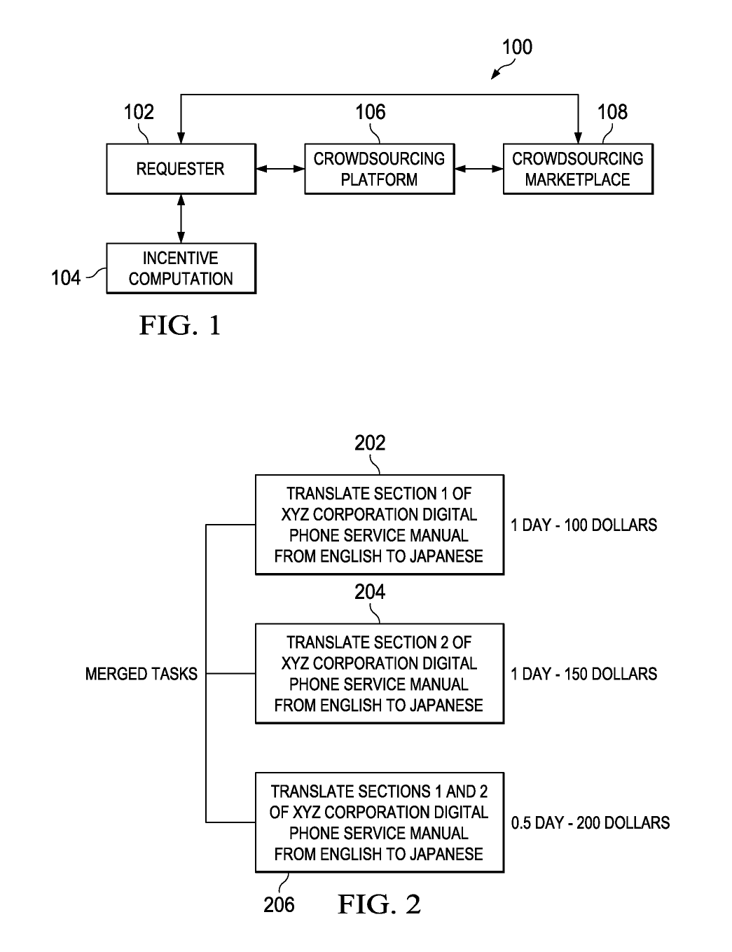

Referring to FIG. 1, there is shown a schematic diagram that illustrates a crowdsourcing system and process 100, and respective entities engaged in such process, as modified by an embodiment of the invention. Generally, requester 102 is an entity such as a business enterprise or other organization that desires to have a particular task performed. Task requester 102 could also be an individual. The task, for example, could be developing or testing a specified software component, or could be another example such as an example described hereinafter in further detail. However, the invention is not limited thereto.

Requester 102 specifies a task requirements description, and provides acceptance criteria to define successful task completion. Requester 102 could also specify start and end dates, and incentives. In accordance with an embodiment of the invention, the requester uses an incentive computation component 104, as described hereinafter in further detail, to determine an incentive amount or value for the task.

Requester 102 initiates the crowdsourcing process by submitting a request for performance of the particular task to a crowdsourcing platform 106. The platform 106 is a broker that posts or presents the task request to the crowdsourcing marketplace 108. This marketplace comprises all the providers of software or other services who may be interested in performing the task, and have the skills and capability to do so. One of these providers may then be subsequently selected to complete the task. Also, if requester 102 is a large corporate entity or the like, crowdsourcing platform 106 could be another component of the same large entity.

FIG. 2 is a schematic diagram that illustrates aspects of an embodiment of the invention. It is to be appreciated that the determination of an appropriate value for an incentive, which is to be offered with a task submitted to the crowdsourcing marketplace, depends on a number of factors or conditions. These include the priority of the task relative to other tasks, the level of skill required and quality of delivery provided by those who will carry out the task, conditions in the crowdsourcing marketplace, and task complexity. Moreover, task urgency, or the time when the task must be completed, can be very important. As used herein, the term “complex task” refers to a task that requires the performance of at least two discrete identifiable smaller tasks, or sub-tasks or atomic tasks. Also, the complexity of the given task increases, as the number of atomic tasks included in the given task increases.

In accordance with embodiments of the invention, it has been recognized that in selecting a task incentive, trade-offs can be made in view of conditions such as those described above. Embodiments of the invention enable the incentive to be adjusted, in order to ensure that absolute requirements for the task are met. FIG. 2 shows a simplified example wherein a trade-off in task complexity can be made, in order to reduce the incentive amount needed for task completion.

FIG. 2 more particularly depicts a task 202, which comprises translation of section 1 of a technical document, referred to as the XYZ Corporation Digital Phone Service Manual, from English to Japanese. Based on the available crowdsourcing marketplace, the task requester anticipates that task 202 will require offering an incentive of $100 US, or the equivalent in another currency. The requester anticipates that a task provider will require one day to complete task 202.

FIG. 2 further shows a task 204, comprising translation of section 2 of the XYZ Corporation Service Manual from English to Japanese. The task requester anticipates that this task will require an incentive of $150 US, and will require one day to complete.

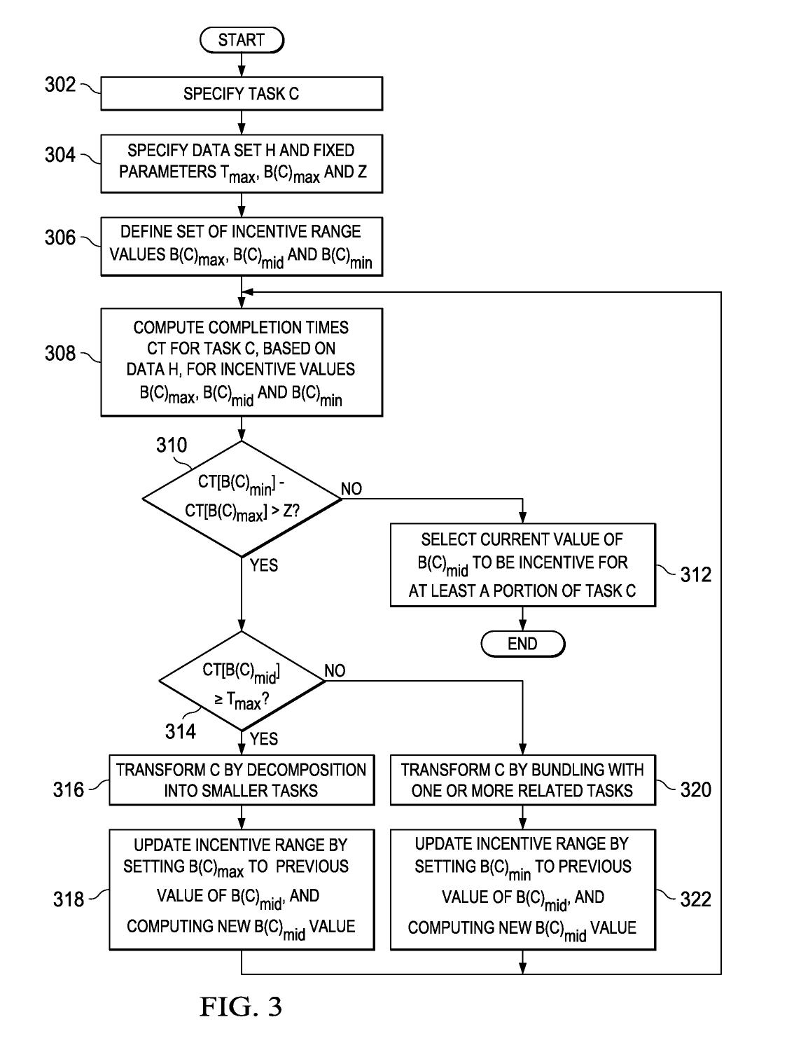

Referring further to FIG. 2, there is shown task 206 comprising a task that is more complex than task 202 or 204. More specifically, task 206 is formed by merging tasks 202 and 204, to require translation of both sections 1 and 2 of the XYZ Corporation Service Manual. This merger or bundling could occur in accordance with an embodiment of the invention, as described hereinafter in further detail in connection with FIG. 3. While the incentive required for this task is $200 US, such amount is less than the $250 total incentive amount which the task requester would need to pay for both the tasks 202 and 204.

As a further benefit for the task requester, FIG. 2 shows task 206 having a completion time of 0.5 day, rather than the one day completion times of tasks 202 and 204. This may occur because the higher incentive offered for the more complex task 206 could encourage crowdsourcing agents with higher levels of expertise to accept task 206. Such an agent could complete task 206 much more quickly than the agents likely to accept tasks 202 or 204.

Referring to FIG. 3, there is shown a flowchart depicting steps of a method comprising an embodiment of the invention. Some or all of the steps of FIG. 3 could be carried out by automated incentive computation component 104, although the invention is not limited thereto. At step 302 task C is specified or defined, wherein the task is to be submitted to a crowdsourcing marketplace for execution. Usefully, task C is a complex task comprising multiple atomic tasks.

The method of FIG. 3 is provided to determine an incentive value for the submitted task that will be optimal. An incentive is optimal if it is the lowest amount which the crowdsourcing requester must offer, in order to attract providers who will have the expertise to meet all requirements of the submitted task.

At step 304 a historical data set H and certain parameters, which are respectively associated with task C, are specified and made available. The parameters include Tₘₐₓ, B(C)ₘₐₓ and Z, wherein Tₘₐₓ is the maximum time that a crowdsourcing provider will have to complete the task C. B(C)ₘₐₓ is the maximum amount, which the crowdsourcing requester has budgeted, to offer as an incentive for task C to the crowdsourcing marketplace. Thus, the final incentive cannot exceed B(C)ₘₐₓ. Z is a parameter which is defined by a system administrator or the like to achieve a desired degree of precision, in the process of determining optimal task incentive.

For a task C of a given type, historical data set H comprises statistical data pertaining to tasks of that type which were previously submitted to the crowdsourcing marketplace. Elements of data set H would include information such as incentive amounts for the previous tasks, required task completion times, and the necessary skill levels. As an example, task C could comprise task 206 of FIG. 2, pertaining to a specified translation of particular technical material. If a number of tasks pertaining to similar translations of the same or similar material had previously been crowdsourced, incentives and completion times associated with those previous tasks would be included in the data set H for task 206. Such information would clearly be very useful, in computing an appropriate incentive for task 206.

Step 306 defines a set of incentive range values, wherein the highest value of the range is initially selected to be B(C)ₘₐₓ. As described above, this is the maximum incentive amount the crowdsourcing requester can offer for task C. The lowest value of the range, B(C)ₘᵢₙ, is initially set to zero. The midpoint or midrange value B(C)_{mid} is B(C)_{mid}=[B(C)ₘᵢₙ+B(C)ₘₐₓ]/².

At step 308, completion times CT are computed for task C using the data set H with each of the incentive values B(C)ₘₐₓ, B(C)ₘᵢₙ, and B(C)_{mid}. These completion times are represented herein as CT[B(C)ₘₐₓ], CT[B(C)ₘᵢₙ] and CT[B(C)_{mid}], respectively. In a useful embodiment of the invention, the computations are carried out by means of an estimated completion time (ECT) function, wherein respective completion times are as follows:

CT[B(C)ₘᵢₙ]=ECT(H, h_{B(C)min}) Expression (1)

CT[B(C)ₘₐₓ]=ECT(H, h_{B(C)max}) Expression (2)

CT[B(C)_{mid}]=ECT(H, h_{B(C)mid}) Expression (3)

In Expressions (1)-(3), the h_{B(C)} term of the ECT functions represents the task C, for the specific incentive values B(C)ₘᵢₙ, B(C)ₘₐₓ, and B(C)_{mid}, respectively. H is a historical set of statistical data, as described above, pertaining to previously crowdsourced tasks of a same or similar type as task C. As further described above, such statistical data includes the incentive amounts and completion times for such previous tasks.

It is anticipated that the function ECT could have a number of different forms, or comprise a number of different processing tools. In one useful embodiment of the invention, ECT comprises a proportional hazard model, such as the Cox proportional hazard model. These are survival models that use statistical information to determine the time when an associated event occurs. One form or model that could be used for the ECT function of Expressions (1)-(3) is described hereinafter in further detail, although embodiments of the invention are by no means limited thereto.

At decision step 310, it is necessary to determine whether completion time CT[B(C)ₘᵢₙ] is greater than completion time CT[B(C)ₘₐₓ], by an amount which exceeds precision Z. That is, it must be determined whether the following inequality is or is not valid:

CT[B(C)ₘᵢₙ]−CT[B(C)ₘₐₓ]>Z Expression (4)

If the inequality of Expression (4) is not valid, the method of FIG. 3 proceeds to step 312, described hereinafter, and thereafter the method ends. Otherwise, the method proceeds to decision step 314. At this step it is necessary to determine whether or not Tₘₐₓ, the maximum time allowed to complete the task, is less than CT[B(C)_{mid}]. That is, step 314 determines whether the following expression is or is not valid:

CT[B(C)_{mid}]≧Tₘₐₓ Expression (5)

If Expression (5) is valid or affirmative, the method proceeds to step 316, and otherwise goes to step 320. If expression (5) is valid, this indicates that the completion time, for an incentive value at the middle of the incentive range, could exceed the allowed task completion time Tₘₐₓ. Accordingly, step 316 addresses this situation by transforming task C into two or more smaller tasks. As an example of this, if task C comprises task 206 of FIG. 2, task C could be transformed or decomposed to task 202, which pertains to translation only of section 1 of the Service Manual from English to Japanese. Translation of section 2 would then be crowdsourced as a separate task.

After transforming task C at step 316, the previous incentive range is updated at step 318, by setting the value of [B(C)ₘₐₓ] for the updated incentive range to the value of [B(C)_{mid}] for the previous incentive range. The value of [B(C)ₘᵢₙ] is the same as [B(C)ₘᵢₙ] for the previous incentive range. [B(C)_{mid}] for the updated incentive range is determined as the sum of [B(C)ₘₐₓ] and [B(C)ₘᵢₙ] for the updated range, divided by two. The process of step 318 thus comprises a bisection of the previous incentive range. Step 318 also has the effect of increasing the incentive for the transformed task in order to reduce completion time.

Following step 318, the transformed task C and updated incentive range values are returned to step 308 is new inputs. Step 308 then computes new completion times for these inputs.

Referring further to FIG. 3, if the method thereof proceeds to step 320, there is an inference that the incentive offered for the task could be reduced, while still achieving task completion within the required time Tₘₐₓ. In view of this, step 320 transforms task C by bundling it with one or more atomic tasks of related type. As an example of this, if task C comprises task 206 of FIG. 2, one or more tasks of translating portions of the Service Manual from English to Japanese, in addition to sections 1 and 2 thereof, could be bundled with task 206.

After transforming task C at step 320, the previous incentive range is updated at step 322, by setting the value of [B(C)ₘᵢₙ] for the updated incentive range to the value of [B(C)_{mid}] for the previous incentive range. The value of [B(C)ₘₐₓ] is the same as [B(C)ₘₐₓ] for the previous incentive range. [B(C)_{mid}] for the updated incentive range is determined as the sum of [B(C)ₘₐₓ] and [B(C)ₘᵢₙ] for the updated range, divided by two. The process of step 322 thus comprises a bisection of the previous incentive range. Step 322 also has the effect of decreasing the incentive for the transformed task.

Following step 322, the transformed task C and updated incentive range values are returned to step 308 as new inputs. Step 308 then computes new completion times for these inputs.

When the method of FIG. 3 is directed to step 312, task C, as then transformed, is selected for submission to the crowdsourcing marketplace. Such submitted task would thus comprise at least a portion of the initially specified task C. The incentive offered with the submitted task would be the then current midrange value [B(C)_{mid}] of the incentive range.

As described above, the ECT function could comprise a proportional hazard model such as the Cox model, although embodiments of the invention are not limited thereto. The Cox proportional hazard model is a semi-parametric model, wherein the hazard function for an individual unit with predictors X has the form

log(h(t,X))=log(h₀(t))+Σᵢ αᵢ·Xᵢ

For the function ECT, completion time would be represented by t in the above hazard function. The predictors X of the hazard function are the dynamic elements thereof. Predictors X would thus include the incentive value for the function ECT, and could further include data as described above in the data set H.

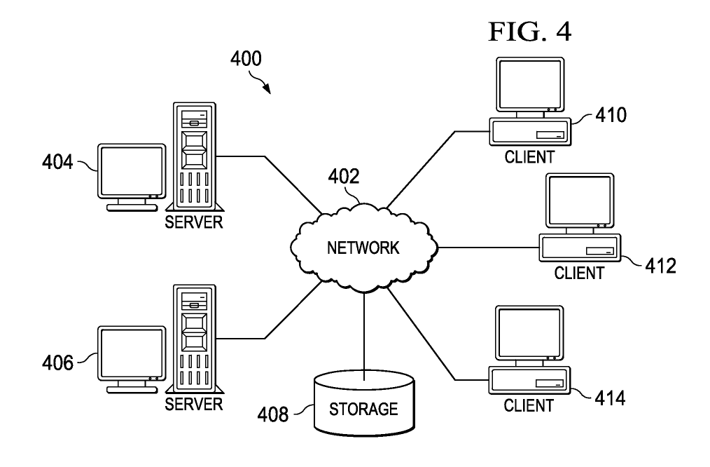

FIG. 4 is a pictorial representation of a network of data processing systems in which illustrative embodiments of the invention may be implemented. Network data processing system 400 is a network of computers in which the illustrative embodiments may be implemented. Network data processing system 400 contains network 402, which is the medium used to provide communications links between various devices and computers connected together within network data processing system 400. Network 402 may include connections, such as wire, wireless communication links, or fiber optic cables.

In the depicted example, server computer 404 and server computer 406 connect to network 402 along with storage unit 408. In addition, client computers 410, 412, and 414 connect to network 402. Client computers 410, 412, and 414 may be, for example, personal computers or network computers. In the depicted example, server computer 404 provides information, such as boot files, operating system images, and applications to client computers 410, 412, and 414. Client computers 410, 412, and 414 are clients to server computer 404 in this example. Network data processing system 400 may include additional server computers, client computers, and other devices not shown.

Program code located in network data processing system 400 may be stored on a computer-recordable storage medium and downloaded to a data processing system or other device for use. For example, program code may be stored on a computer-recordable storage medium on server computer 404 and downloaded to client computer 410 over network 402 for use on client computer 410.

In the depicted example, network data processing system 400 is the Internet with network 402 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 400 also may be implemented as a number of different types of networks, such as, for example, an intranet, a local area network (LAN), or a wide area network (WAN). FIG. 4 is intended as an example, and not as an architectural limitation for the different illustrative embodiments.

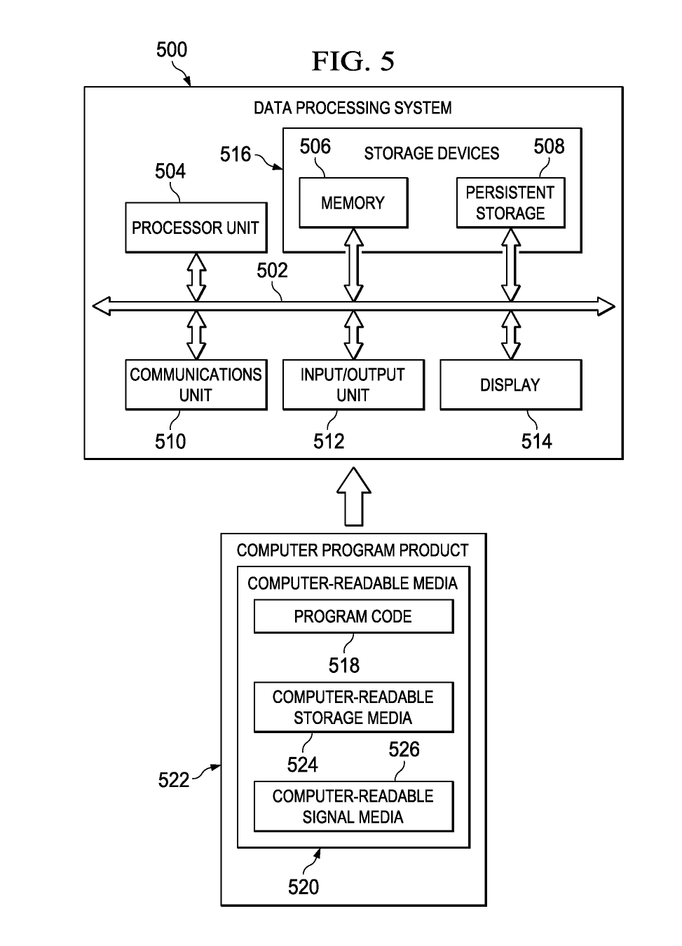

Turning now to FIG. 5, an illustration of a data processing system is depicted in accordance with an illustrative embodiment. The data processing system may be used as one or more of the components for system 100. In this illustrative example, data processing system 500 includes communications fabric 502, which provides communications between processor unit 504, memory 506, persistent storage 508, communications unit 510, input/output (I/O) unit 512, and display 514.

Processor unit 504 serves to execute instructions for software that may be loaded into memory 506. Processor unit 504 may be a number of processors, a multi-processor core, or some other type of processor, depending on the particular implementation. A number, as used herein with reference to an item, means one or more items. Further, processor unit 504 may be implemented using a number of heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device is any piece of hardware that is capable of storing information, such as, for example, without limitation, data, program code in functional form, and/or other suitable information either on a temporary basis and/or a permanent basis. Storage devices 516 may also be referred to as computer-readable storage devices in these examples. Memory 506, in these examples, may be, for example, a random access memory or any other suitable volatile or non-volatile storage device. Persistent storage 508 may take various forms, depending on the particular implementation.

For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508.

Communications unit 510, in these examples, provides for communications with other data processing systems or devices. In these examples, communications unit 510 is a network interface card. Communications unit 510 may provide communications through the use of either or both physical and wireless communications links.

Input/output unit 512 allows for input and output of data with other devices that may be connected to data processing system 500. For example, input/output unit 512 may provide a connection for user input through a keyboard, a mouse, and/or some other suitable input device. Further, input/output unit 512 may send output to a printer. Display 514 provides a mechanism to display information to a user.

Instructions for the operating system, applications, and/or programs may be located in storage devices 516, which are in communication with processor unit 504 through communications fabric 502. In these illustrative examples, the instructions are in a functional form on persistent storage 508. These instructions may be loaded into memory 506 for execution by processor unit 504. The processes of the different embodiments may be performed by processor unit 504 using computer implemented instructions, which may be located in a memory, such as memory 506.

These instructions are referred to as program code, computer-usable program code, or computer-readable program code that may be read and executed by a processor in processor unit 504. The program code in the different embodiments may be embodied on different physical or computer-readable storage media, such as memory 506 or persistent storage 508.

Program code 518 is located in a functional form on computer-readable media 520 that is selectively removable and may be loaded onto or transferred to data processing system 500 for execution by processor unit 504. Program code 518 and computer-readable media 520 form computer program product 522 in these examples. In one example, computer-readable media 520 may be computer-readable storage media 524. Computer-readable storage media 524 may include, for example, an optical or magnetic disk that is inserted or placed into a drive or other device that is part of persistent storage 508 for transfer onto a storage device, such as a hard drive, that is part of persistent storage 508. Computer-readable storage media 524 also may take the form of a persistent storage, such as a hard drive, a thumb drive, or a flash memory, that is connected to data processing system 500. In some instances, computer-readable storage media 524 may not be removable from data processing system 500. Computer-readable media 520 could also include a computer-readable signal media 526 in some embodiments.

The different components illustrated for data processing system 500 are not meant to provide architectural limitations to the manner in which different embodiments may be implemented. The different illustrative embodiments may be implemented in a data processing system including components in addition to or in place of those illustrated for data processing system 500. Other components shown in FIG. 5 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 504 may take the form of a hardware unit that has circuits that are manufactured or configured for a particular use. This type of hardware may perform operations without needing program code to be loaded into a memory from a storage device to be configured to perform the operations.

For example, when processor unit 504 takes the form of a hardware unit, processor unit 504 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 518 may be omitted because the processes for the different embodiments are implemented in a hardware unit.

In still another illustrative example, processor unit 504 may be implemented using a combination of processors found in computers and hardware units. Processor unit 504 may have a number of hardware units and a number of processors that are configured to run program code 518. With this depicted example, some of the processes may be implemented in the number of hardware units, while other processes may be implemented in the number of processors.

As another example, a storage device in data processing system 500 is any hardware apparatus that may store data. Memory 506, persistent storage 508, and computer-readable media 520 are examples of storage devices in a tangible form.

In another example, a bus system may be used to implement communications fabric 502 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 506, or a cache, such as found in an interface and memory controller hub that may be present in communications fabric 502.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. In association with a specified task of a given type which is to be submitted for execution to a crowdsourcing marketplace, wherein task execution must be completed within a specified maximum time, and an incentive offered for task execution cannot exceed a specified maximum incentive value, a method comprising the steps of:
computing an initial incentive range having values for a minimum incentive, a midrange incentive, and a maximum incentive, wherein the maximum incentive is equal to the specified maximum incentive value:
acquiring historical data pertaining to tasks of the given type which were previously executed by crowdsourcing, wherein the historical data includes at least completion times and incentives of the previously executed tasks;
using the historical data with the minimum incentive, the midrange incentive and the maximum incentive to compute, respectively, a minimum incentive task completion time (CT[B(C)ₘᵢₙ]), a midrange incentive task completion time (CT[B(C)_{mid}]), and a maximum incentive task completion time (CT[B(C)ₘₐₓ]);
selectively processing CT[B(C)ₘᵢₙ], CT[B(C)_{mid}], and CT[B(C)ₘₐₓ] to determine whether a first criterion, a second criterion or a third criterion has been complied with;
responsive to determining that either the first criterion or the second criterion has been complied with, selectively transforming the specified task, and computing an updated incentive range for the transformed task; and
using the transformed task and updated incentive range in computing a final incentive value, for submission with at least a portion of the specified task to the crowdsourcing marketplace.

2. The method of claim 1, wherein:
responsive to the first criterion or the second criterion being complied with, selectively, a bisection technique is used to compute the updated incentive range.

3. The method of claim 1, wherein:
the first criterion is complied with, when the difference |CT[B(C)ₘᵢₙ−CT[B(C)ₘₐₓ]| is greater than a specified precision parameter, concurrently with the condition that CT[B(C)_{mid}] is no less than the specified maximum time for task completion.

4. The method of claim 1, wherein:
responsive to the first criterion being complied with, an updated modified incentive range is computed having an updated maximum incentive value that is less than the maximum incentive of the initial incentive range.

5. The method of claim 4, wherein:
the updated incentive range has an updated maximum incentive value equal to the midrange incentive of the initial incentive range.

6. The method of claim 1, wherein:
the specified task comprises two or more atomic tasks, and responsive to the first criterion being complied with, the specified task is transformed by removing at least one of the atomic tasks from the specified task.

7. The method of claim 1, wherein:
the specified task comprises one or more complex tasks, each complex task including two or more atomic tasks, and responsive to the first criterion being complied with, the specified task is transformed by removing at least one of the atomic tasks from its complex task.

8. The method of claim 1, wherein:
the second criterion is complied with, when the difference |CT[B(C)ₘᵢₙ]−CT[B(C)ₘₐₓ]| is greater than a specified precision parameter, concurrently with the condition that CT[B(C)_{mid}] is less than the specified maximum time for task completion.

9. The method of claim 1, wherein:
responsive to the second criterion being complied with, an updated incentive range is computed having an updated minimum incentive value that is greater than the minimum incentive of the initial incentive range.

10. The method of claim 9, wherein:
the updated incentive range has an updated minimum incentive value equal to the midrange incentive of the initial incentive range.

11. The method of claim 1, wherein:
responsive to the second criterion being complied with, the specified task is transformed by bundling the specified task with one or more other tasks.

12. The method of claim 1, wherein:
the third criterion is complied with when the difference |CT[B(C)ₘᵢₙ]−CT[B(C)ₘₐₓ]| is no greater than a precision parameter, which is prespecified to achieve a desired degree of precision.

13. The method of claim 1, further comprising:
iteratively carrying out one or more sets of steps until the third criterion is complied with, wherein each set comprises a first step and a second step, a first step comprising transformation of either the specified task or the most recent transformation of the specified task, selectively, and a second step comprising computation of an incentive range for the then current task transformation.

14. The method of claim 13, wherein:
responsive to the third criterion being complied with, selecting the midrange incentive of the most recently computed incentive range to be the final incentive value.

15. The method of claim 1, wherein:
a proportional hazard model is used in respectively computing CT[B(C)ₘᵢₙ], CT[B(C)_{mid}], and CT[B(C)ₘₐₓ].

16-25. (canceled)
